(19) United States
(12) Patent Application Publication
(10) Pub. No.: US 2007/0208751 A1
(43) Pub. Date: Sep. 6, 2007

(54) PERSONALIZED CONTENT CONTROL

(76) Inventors: David Cowan, Atherton, CA (US); Justin Label, San Francisco, CA (US); Johan Sundstrom, Linkoping (SE)

Correspondence Address: STRATEGIC PATENTS P.C.., C/O PORTFOLIOIP, P.O. BOX 52050, MINNEAPOLIS, MN, 55402, US

(21) Appl. No.: 11/562,869

(22) Filed: Nov. 22, 2006

Related U.S. Application Data
(60) Provisional application No. 60/739,580, filed on Nov. 22, 2005.

(51) Int. Cl. G06F 17/30

(52) U.S. Cl. 707/10; 707/3

(57) ABSTRACT

A content modification platform facilitates personalized presentation and interaction associated with content such as web content, document content, transactional content, multimedia content, and the like. The platform provides sharing of personalization features to facilitate developing a community view of content, such as the internet Menu features are configured to modify source content through simple commands such as add, delete, replace targeted toward content and links to content. The content modification platform is beneficially and effectively used in a variety of on-line content types, environments, transactions, business activity, e-commerce, stock trading, education, human resources and many others. By facilitating a user defining what relationships between and among content is important to them, a customized view of the internet can be presented to the user.

### RELATED APPLICATIONS

This application claims the benefit of commonly-owned U.S. App. No. 60/739,580 filed on Nov. 22, 2005, the entire contents of which are incorporated herein by reference.

### BACKGROUND

1. Field

This disclosure relates to personalized content control, and more particularly to user-definable hyperlinks and other content that can redefine the presentation of a network, web, subset of the web, website, content, and the like.

2. Description of the Related Art

The traditional World Wide Web, or web, contains fixed hyperlinks 192. The hyperlinks 192 are typically embedded in HTML code and imply a structure to the web upon which users can navigate from page to page. Authors, publishers, content creators, and others may insert hyperlinks 192 based on their assessments of what is valuable and/or interesting to readers. Authors, publishers, content creators, and others may also insert hyperlinks 192 based on their assessments of what is valuable to them, such as by including advertisements, marketing their goods and services, and defining the boundaries of a website such that a user does not leave a website. This process may be incomplete since, even when acting in a benevolent manner, an author, publisher, content creator, or another, may not know all the possible potential links or relevant links that may exist on the web. In addition, there is much variation in the content that is of interest to different users. As a result, these limitations may limit the utility of the web.

### SUMMARY

A content modification platform, herein described, may be used for the manipulation of content such as web content, document content, video content, audio content, media content, or other content where customization of the content is desired. The content modification platform may overcome the aforementioned limitations and provide highly customized presentation of the web (or any selected content) through dynamic command based modification of content as it is presented to a user.

Systems and methods of the present invention may provide a content modification platform; associate the content modification platform with a content environment; define a plurality of available content modifications that are associated with the modification platform, the plurality of available content modifications being based on at least one of the nature of the content environment and a plurality of content modification sources; present the plurality of available content modifications to a user in the content environment; and upon input by the user, modify the content in the content environment using content from at least one content modification source. These modifications may include inserting links to content, changing a URL within a link, changing size of content, changing color of content, changing multimedia effects of content, and so on.

The content may be at least one of a web site, a web page, a document, a message, an explorer view, a database, an email 164, an RSS feed, a task, a business platform, a media item, an advertisement, a transactional item, a game, and an industry platform. Modifying the content may be based on a relevance of a aspect of the content, wherein the aspect may be metadata associated with the content, a domain of the content, a URL of the content, keywords of the content, and so on. Modifying the content may include finding keyword in the content, adding content, and so on.

The content modification platform may embody at least one of a local program, a client program, a server program, a web browser plug-in, a web service, a DOM API, and so on.

Presenting the plurality of available content modifications may include presenting a menu features that is associated with a content source. The menu feature 102 may be a publishing feature, a purchasing feature, a downloading feature, and so on.

Content may be available for sourcing by at least one of email 164, instant messaging, text messaging, ftp transfer, voice over IP, peer to peer file sharing, and so on.

Systems and methods of the present invention may provide a content modification platform, select content, select alternate content, define a menu feature that associates the content to the alternate content, and connect the menu feature to the platform so that the menu features is available to a user of the platform. These systems and methods may further comprise selecting the menu features to take an action that results in a presentation of modified content based on the defined content association. The action may include at least one of adding, removing, translating, paraphrasing, expanding, highlighting, disguising, converting, redirecting, previewing, and so on. The menu feature 102 may be user defined, self-authored, purchased, authored by a third party, automatically generated, and so on.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIGS. 1 and 1a depict a content modification platform, exposing various details of the platform features, elements, methods, target content, and modification targets.

### DETAILED DESCRIPTION

For the purpose of making the following disclosure easier to read, we may use the verb “to modify” as shorthand for “to add, to delete, to insert, to remove, to refresh, to revise, to update, and/or to alter.” So, for example, a phrase such as “the user may modify the content” may be understood as “the user may add, delete, insert, remove, refresh, revise, update, and/or alter the content.” Similarly, the noun “modification” may be used as shorthand for “addition, deletion, insertion, removal, refreshed version, revision, update, and/or alteration.” Furthermore, it will be appreciated that the words “link” and “hyperlink” are used interchangeably throughout this document except in cases where it is clear by context that this is not so.

Throughout this disclosure we may use the term “webpage,” “web page,” “page,” “target page,” “source content,” or “original content” in examples and embodiments. These terms should be understood to include a wide variety of content such as web pages retrieved from the internet, an intranet, or locally. These terms should also be understood to include content associated with any form of electronic representation such as documents (text, graphic, paginated, and the like), email 164s (heading, addresses, body, signature, attachments, embedded images, and the like), messages (instant, text, and the like), video, audio, electronic transactions, and the like.

References to “text” and/or “word” should be understood to include any combination of text, numerals, words, images, and the like such as a phrase, sentence, paragraph, table, formula, and the like.

In order to make this document easier to read, we note our examples with phrases such as “for example,” “in one example,” “such as,” and so on. “In an example” and the like shall mean “for example and without limitation” in all cases except as stated otherwise.

References in this document to “transferring” shall mean transferring data by any means, including and without limitation, text messaging, electronic mail, IP telephony, and any other means of transferring data.

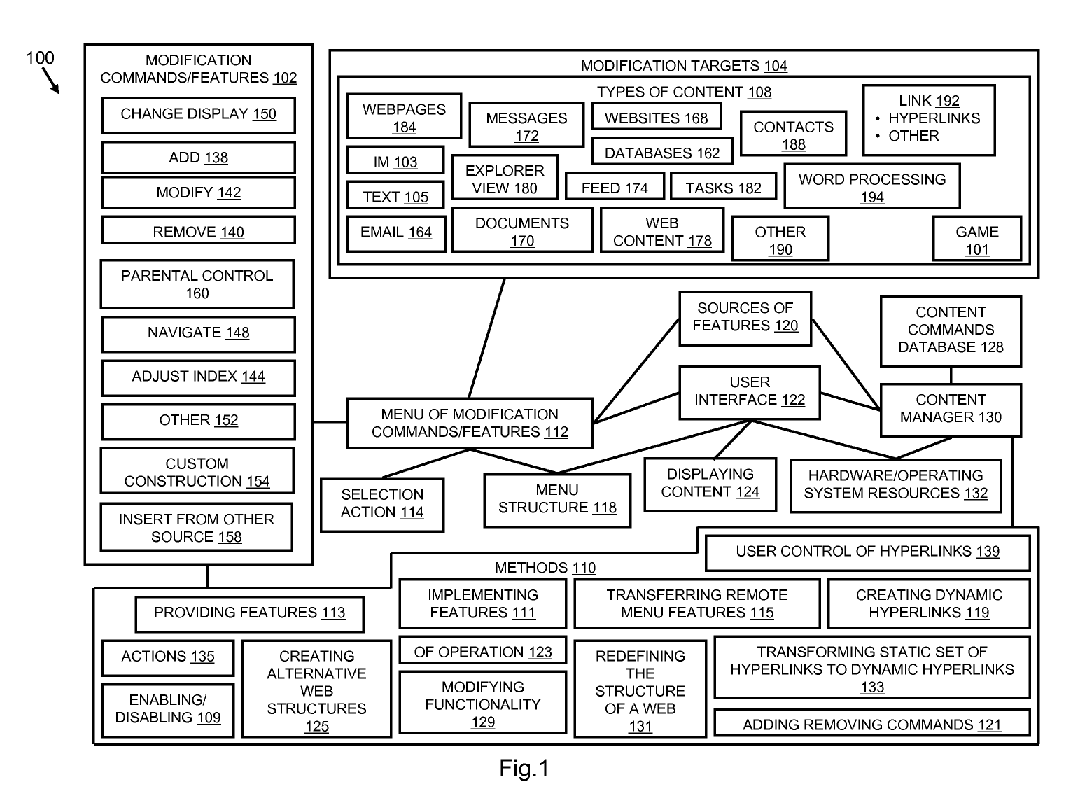

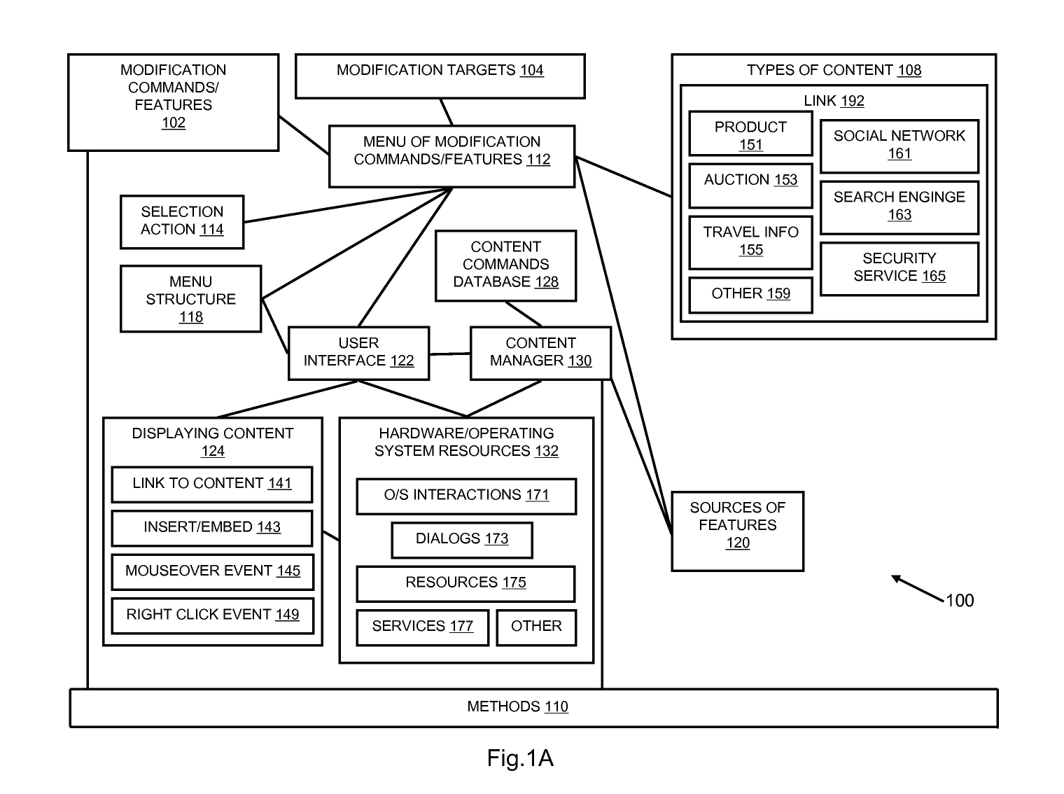

The content modification platform 100 depicted in FIG. 1 and FIG. 1A may facilitate manipulation of content through use of menus for user selection of modification features and an underlying content management 130 infrastructure of methods 110. The content modification platform 100 provides a user with a wide variety of content modification commands/features 102 that define modification operations such as adding 138, removing 140, modifying 142, replacing and disguising content, adjusting an index 144, manipulating navigation 148, changing content display 150, other commands/features 152, custom construction 154, insertion of content from another source 158, parental control 160, and the like. These modification commands/features 102 may be selected and managed from a menu of modification commands/features 112 that is accessed from a user interface 122. Modification targets 104 (content or sources of content) may be identified through the menu of modification commands/features 112 and may include a wide variety of content types 108 such as databases 162, email 164, websites 168, documents 170, instant and text messages 172, feeds 174 (such as and without limitation RSS feeds), web content 178, an explorer or content navigation view 180, a task 182, a webpage 184, a content 188, an other target 190, a link 192, a word processing file 194, an email 164, a game 101, a instant message 103, text 105, and the like. In addition to identifying content modification targets 104, content to be modified or to be linked to during modification may be identified by type of content 108.

The infrastructure of methods 110 may enable much of the functionality such as enabling/disabling features 109, implementing features 111, sourcing or providing features 113, transferring remote user features 115, creating dynamic hyperlinks 119 (from static to dynamic) 119, adding or removing modification commands 121, generally operating the platform 123, creating alternative web structures 125, modifying functionality 129, redefining the structure of a web 131, transforming a static set of hyperlinks 192 to dynamic hyperlinks 133, actions 135, user control of hyperlinks 192 139, and so on.

The user interface 122 may further allow access to a content manager 130, while supporting actions such as displaying content 124 and displaying a menu structure 118. The content manager 130 accesses a content command database 128 that holds the commands, definitions, and references used to modify content. The content manager 130 further uses the infrastructure of methods 110 to execute the modifications, while facilitating managing sources of features 120.

As can be seen in FIG. 1a, displaying the content 124 may comprise linking to the content 141, inserting/embedding the content 143, displaying the content in response to a mouse-over event 145, displaying the content in response to a right-click event 149, and so on.

The user interface 122 may further facilitate displaying content 124 in a way that allows a user to receive feedback from the platform simply by using the computer user interface 122 cursor/pointer (as may be provided by the local hardware/operating system resources 132) to mouse over 145 or select content.

FIG. 1A also provides further insight into types of content linking. Types of content links may include links to and/or from a product 151, a social network 161, a security service 165, travel information 155, a search engine 163, an auction 153, other 159, and the like.

Embodiments of the present invention may modify, support, act upon, or otherwise be associated with various types of content including the following: a link; a link structure; a word; text (such as and without limitation a word, a phrase, a sentence, a title, and so on); audio; a graphic; an image; video; a URL; a feed; a file; a directory entry; a database entry; a name; a username; an account; account information; favorite information; a reference; content control information; other content; web content; a webpage; a website; a document; a message; an explorer view; a database; email 164; an RSS feed; a contact (such as and without limitation personal contact information); a task; and so on. The content may comprise a link in the webpage, which may encompass a link provided by the webpage author, a software application according to the present invention, a third party, and so on. The link in the webpage may be static, dynamic, transmitted to a web browser by a web server, inserted into the webpage by a web browser or other software, and so on. The content may be displayed in an email 164 or email 164 attachment; an instant message; a word processing document; a game; a user interface 122 of a program; a web browser; and so on. Many types of content 108 will be appreciated and all such content is within the scope of the present disclosure. When the content is to be modified it may be referred to herein and elsewhere as a modification target 104.

A menu of modification features 112 may be provided as a toolbar user interface 122 or a menu user interface 122. The toolbar user interface 122 may comprise a field for dynamic index creation, which can be used by a user while the user is surfing content. In an example, a user may visit a webpage, highlight text in the webpage, and then use the toolbar user interface 122 to modify a term or tag for the highlighted text. This modification may more or less immediately be reflected in the webpage as a modification of a link that is associated with the highlighted text. The menu user interface 122 may be part of a user interface 122 menu structure 118, which may be integrated into or associated with a web browser, a webpage, a word processor, an RSS reader, an email 164 or email 164 application, an instant message or instant messaging application, any other user-level computer program providing a user interface 122 (such as and without limitation a desktop application, and the like), any other system-level computer program providing a user interface 122 (such as and without limitation an operating system, a finder of an operating system, and so on), and so forth. In any case, the menu of modification features 112 may be displayed by selecting content within a webpage. Selecting content may comprise clicking on the content, highlighting the content, performing a regular expression match against the content, and so on.

The menu of modification features 112 may provide numerous types of features, which may be directed at changing navigational features of the content such as and without limitation how the content is displayed 124 for navigation, a hyperlink 119 that is associated with the content, a link structure that is associated with the content, and so on. In embodiments, modifying hyperlinks 192 may change how the content is displayed 124 for navigation. In an example, hyperlinks 192 119 that are embedded in and/or associated with the content may be displayed 124 along with content so as to provide a navigation feature. Those of skill in the art will appreciate many such navigation features, all of which are within the scope of the present disclosure. The menu of modification features 112 may provide for enabling, disabling, installing, uninstalling, grouping, ungrouping, registering, activating, deactivating, and/or configuring the modification features.

A modification feature 102 may function automatically, continuously, from time to time, in response to a signal, upon or in association with downloading content, and so on. The modification feature 102 may function by downloading content and modifying aspects of the content in a background process. The modification feature 102 may be implemented in a standalone application, an application module, an applet, a servlet, a plug-in, a client-side script, a server-side script, and so on. Many implementations of the modification feature will be appreciated and all such implementations are within the scope of the present disclosure.

A modification feature 102 may add information to content so as to change how the content is displayed 124 for navigation. The added information may comprise a link 119 or hyperlink 119. The link may be static or dynamic. The link may be inbound or outbound. The content may comprise any kind of content including, without limitation, text, images, color, and so on.

A modification feature 102 may alter content so as to change how the content is displayed for navigation. Such alteration may, without limitation, encompass translating, paraphrasing, expanding or explaining, highlighting or warning, disguising, converting, and so on. Alterations that encompass highlighting or warning may be associated with content that is deemed unsafe, adult-oriented, illegal, inflammatory, completely or nearly unavailable (such as and without limitation due to the content's removal from a server, a network overload or failure, a server overload or failure, and the like), and so on. Alterations that encompass converting may be related to currency, time, and so on. In an example and without limitation, content that shows the price of a gallon of milk in a website published in 1999 may be converted to show today's price of a gallon of milk. The source content price of milk and the converted price of milk may be the same or different currency.

A modification feature 102 may alter a link that is embedded in and/or associated with the content so as to change how the content is displayed 124 for navigation. Such alteration may, without limitation, remove the link, insert the link, replace the link, and so on. The link may provide a navigational redirection away from an out-of-service resource and toward a mirrored, cached, backed-up, or alternate version of the resource. The link may be altered so as to point to content that is associated with a thesaurus, a dictionary, a Wiki (such as and without limitation the Wikipedia), a preview, and so on.

A modification feature 102 may modify content so as to change how the content is displayed 124 for navigation. In embodiments, the modification feature 102 may provide a parental control feature. In one example, the modification feature 102 may detect sexually explicit language in a webpage and may remove or alter that content after a web browser downloads it but before the web browser displays it. In embodiments, the modification feature 102 may provide a custom construction feature. In an example, the modification feature 102 may download a plurality of content from one or more sources and construct a webpage that comprises the content. When a web browser displays the webpage, the webpage may appear as though it originates from a single source or a central server facility.

A modification feature 102 may be associated with an action that is applied to selected and/or unmodified content. Without limitation, this action may comprise modifying the content, navigating the content associated with the content, adjusting an index that is associated with the content, and so on.

A source of features 120 may provide and/or specify a modification feature. The source 120 may, without limitation, encompass a user, a third party, a vendor, an automatic process, and so on. Thus, the modification feature 102 may be user-defined, self-authored, purchased, third-party authored, auto-generated, and so on. In any case, the modification feature 102 may be published, purchased, downloaded, transferred (such as and without limitation via email 164, instant messaging, VoIP, an online communication facility, and so on), and so forth.

A modification feature 102 may embody one or more various methods 110. In embodiments, the method 110 may use a text filter to find a keyword and convert the content into an executive summary that contains a subset of words from the content that are selected according to their information value. Additionally, the method 110 may perform a lookup in association with the subset so as to locate information and/or links that are associated with those words. In embodiments, the lookup may be implemented with a bloom filter or any and all other types of filter. These and other methods 110 may be deployable in a variety of contexts. In an example, a client-side full-text mapping of words to URLs may be provided. In this example, the methods 110 may process content so as to locate text in the content that matches the words in the mappings. In another example, a remote cache and/or distributed cache of mappings may be used to process content to locate text in the content that matches the words in the mappings. In still another example, one or more regular expressions may be utilized by the client to detect matches in the content. In any case, a client may perform a server lookup to retrieve links, content, regular expressions, features, and so on. The forgoing examples are related to text content; however, the one or more methods 110 of embodying and/or implementing modification features may also relate to any form of content including images, video, audio, and the like, and combinations thereof.

A modification feature 102 may be implemented in or in association with a local program, a client project, a web browser plug-in, a web service, a server program, a DOM API, another software application, a programming language, and so on. The programming language may comprise JavaScript, Ajax, XML, and so on.

A content modification platform 100, as defined herein or elsewhere, may provide functionality that includes, without limitation, content addition facility features, removal facility features, or other features. The content addition and/or removal facility features may be used for marking links to a user's content, sites, services, other sites, and so on. Such a feature 102 may be used to improve the discoverability of the sites and/or content by presenting the marked links differently than other links in the content. In an example, a marked link may include a visible outline around the content (text, image, and the like) that is associated with the marked link. It may also be used for various other purposes including, without limitation, tracking the online public opinion or buzz circulating about a site. Alternatively or additionally, the content addition and/or removal facility feature 102 may create and show a list of inbound or outbound links for finding content relevant to the target page's content. Such a feature 102 may be implemented by using a search application program interface such as the Google or Yahoo! content search Application Programming Interfaces (APIs), and the like.

A feature labeled “Original” that reinserts or removes the target page's original hyperlinks 192 119 is another example of a content addition and/or removal facility. The Original feature 102 may present the content as originally sourced. The Original feature 102 may be used to toggle the presentation of the original hyperlinks 192 and/or certain content. In an example, a user may use the Original feature to undo modifications that were made to the content, to remove old content/links when updating the content, to update links to the latest news in a weblog, to undo modifications that other users made to the content, and so on.

Another example is a feature labeled “Wiki” that inserts or removes content to a Wiki, such as supported by Wikipedia at Wikipedia.org. The Wiki feature may choose content on the target web page and find entries in a Wiki, such as Wikipedia, that correspond to the content and create hyperlinks 192 or insert the corresponding content. In an example, a user may use the Wiki feature while reading a news article to create links on the names of people involved, links to the important dates, links to key technologies mentioned and/or links to the locations mentioned in the article. In another example, a user could use the Wiki feature while reading a technical article or professional journal to create links to important concepts mentioned in the article so that the user could verify the target page's author's arguments.

Another content addition and/or removal feature 102 may be associated with a social book marking facility, such as “del.icio.us.” Social book marking sites can be seen as popularity rankings for the web, on subjects denoted by user-provided tags. A social book marking site may provide social book marking where users save bookmarks for web pages on the social book marking site. The bookmarks are tagged and organized by their tags. The del.icio.us feature would map content and/or links in the target page to content and/or links similarly tagged in del.icio.us.

A feature labeled “Kids” is another example of a content addition and/or removal facility. As applied to content, such a feature could modify content to child-safe news, games, educational content, and the like. In an example, a parent user could employ the Kids feature while his kids are using a computer to browse the internet. The feature 102 may provide child-friendly content on any and all web pages, downloaded content, pop-up windows, email 164, instant messaging, and the like while perhaps removing content and/or links that are not child-friendly.

There may also be a content addition and/or removal facility feature labeled “Bid.” As applied to content, such a feature could modify content associated with an auction and wherein the auction is associated with the source content. The inserted and/or removed content may, without limitation, relate to one or more of the following: items; ideas; concepts; goods that are to the target page's content; complementary goods; similar services; complementary services; substitute goods; substitute services; and so on. In an example, a user may be browsing a movie review and may use the Bid feature to find auctions selling the movie on DVD; a user may be reading about a sports team and may use the Bid feature to find auctions that include paraphernalia for that team; a user may be reading an article on how to build something and may use the Bid feature to find all the parts and components the user needs to build the item; and the like. The Bid feature 102 may access one or more on-line auction systems such as eBay.

Another possible addition/removal facility feature is a feature labeled “Map.” This feature 102 may modify a webpage so as to include or remove content that encompasses a map. The content may be from an online map provider such as Google Maps, MapQuest, or some other provider. This feature could be used by a person who would like to map the location of an address that is contained in a webpage without leaving the webpage and without popping up an additional browser window or tab. In an example, the Map feature could be employed by a user who is reading a webpage about the history of a city or area; who is planning a vacation; who is preparing to travel to a business meeting; and so on. In another example, the Map feature could be employed by a user who is correlating multiple locations with one another to correlate a series of events, such as finding maps to baseball stadiums to plan a trip to attend baseball games at multiple stadiums, and so on.

There could be an addition/removal facility feature labeled “Calendar.” This feature could modify content in certain content in the target web page. The content may be from any calendar source, including, but not limited to, a local calendar on the local machine, a shared calendar on a network, or an online calendar. The content may include without limitation that week's schedule, that date's schedule, or some other view of the calendar. Since the user's information will be available for accessing the calendar, the calendar's functionality may be extended from the host site or program to the rest of the internet. The calendar service host or provider may be interested in extending the reach and usefulness of its calendar for its end users and may cooperate in creating and maintaining the feature.

Another possible addition/removal facility feature could be labeled “Contacts”. This feature 102 may modify a webpage's content that is related to contact records. The content to be added or removed could be linked to certain content on the web page including, but not limited to, names, email 164 addresses, mailing addresses, phone numbers, instant messaging handles, and other contact information. The contact records may be stored in a database 162 such as, but not limited to, an Outlook contacts database, a Yahoo! contact list, or a Gmail contact list. In an example, the Contacts feature could be used by a user who wants to get a friend's phone number so the user can call and check in on the friend after reading the friend's latest weblog entry; the Contacts feature could insert a friend's email 164 address when the user reads about the friend in a weblog; the Contacts feature 102 may be used to get the user's accountant's phone number so the user can fire the accountant after reading an article about recent fraud charges brought against the accountant; and so on.

An addition/removal facility feature labeled “Book Burrow” could modify content related to books and similar products. Such a feature 102 may modify content to book prices, synopses, critiques and/or other related content based on certain content in the web page. The content in the web page used to map the information may include, but not be limited to, author's names, character's names, plot elements, story and/or chapter titles, themes, topics, locations, other features of the book, and so on. In an example, the Book Burrow feature could be used to find and compare prices of a book the user saw on the New York Times Bestseller list; a user could use the Book Burrow feature to get links to critiques of a book that was cited in an article the user was reading; and so on.

An example of another possible addition/removal facility feature is one labeled “Networking” that inserts or removes content from an on-line networking site (such as LinkedIn) into a web page corresponding to the names in the web page's content. In an example, a user may turn on the Networking feature while viewing a posting for a job opening to see if the user has any contacts at the hiring company or if the user has any contacts that do similar work that could help the user prepare for an interview; a user at a company who receives an email 164 listing job openings may use the Networking feature to search the user's networking contacts to see if the user has any friends that are good fits for an opening with the user's employer; a user may look at a company report about target markets with the Networking feature in order to see if the user has contacts with potential clients who are in those target markets; and so on.

There may also be an addition/removal facility feature labeled “Travel” that modifies content in certain content associated with travel information. The travel information may include, but is not limited to, flight prices, flight information, car rental prices, hotel prices and availability, travel packages and other travel information. The information may be associated with the target page's content based on content including, but not limited to, the following: names of places; activities; historical events; landmarks; people; addresses; dates; holidays; and other information. In an example, a user who is reading an email 164 from his parents that is asking about travel plans for the holidays may use the Travel feature to quickly find plane tickets and book flights; a user reading about a conference in Las Vegas may use the Travel feature to compare hotel rooms and plane tickets, and purchase the package the user likes best; and so on. The Travel feature 102 may access on-line travel services such as Orbitz, Travelocity, and the like to retrieve the relevant information.

Another possible addition/removal facility feature 102 may be customized for a user. In an example, a user named Ron may provide access to a feature labeled “Ron's Picks”. This feature 102 may modify content in certain content associated with other sites or content that Ron believes is interesting. In an example, a user named Ron could use the Ron's Picks feature on his weblog to insert content to which he wants his weblog to link; or Ron could use the Ron's Picks feature to remove the links in his weblog when someone else is using his computer to read his weblog. In another example, one of Ron's friends could use the Ron's Picks feature created by Ron to get a set of suggested links that Ron thinks are interesting.

There may be an addition/removal facility feature labeled “Social Cross” that modifies content to cross-reference identities (such as and without limitation names, aliases, and the like) in social networking sites. With this feature, a user could immediately or incrementally teach the addition/removal facility to track certain identities, to associate identities with one another, and so on. The Social Cross feature could also probe online communities to find information pertaining to the availability of a specific alias, to verify that identities from different communities map to a person (such as and without limitation by accessing friend-of-a-friend RDF data), and so on.

A feature labeled “Annotate” is another example of an addition/removal facility feature. This feature 102 may modify content and allow the user to enter notes associated with the content. In one example, a user may use the Annotate feature to create notes about which links are broken so that the web page host or author can update the links; a user could use the Annotate feature to give notes to the content author regarding factual errors or typos; or a user could turn on the Annotate feature in order to leave notes on a friend's weblog in response to the friend's most recent post. The user's notes may also be used for personal reference or for sharing with other users without the involvement of the content creator/host. In an example, users could leverage the Annotate feature to create a third party discussion space regarding the topic of the page where the discussion is posted.

A feature labeled “Preview” that modifies content in order to provide instant preview samples is an example of another possible addition/removal facility feature. Such a feature could be used to modify previews of content associated to the target web page's content. Such associated content may include, but is not limited to, audio content, video content, text, a Flash application, or other content. In an example, a user could use the Preview feature to find and watch trailers to movies about which the user is reading a preview; a user could use this feature to see trailers for all the films and television shows an actor has listed in his filmography in the Internet Movie Database (IMDB) web site; or a user could use this feature to access to clips of the user's favorite band's forthcoming album; and so on.

A feature labeled “Compare” that modifies content for price or product/service comparisons is an example of another possible addition/removal facility feature. The Compare feature could use detectable article identifiers (such as ISBNs, EAN codes, microformats, other identifier formats, and so on) to find similar products/services on other web site stores and compare the prices. In an example, a user who wanted to compare prices from multiple online stores could use the Compare feature and get prices on a new DVD, videogame console, plasma television or other good that can be purchased online.

Another example addition/removal facility feature labeled “I'm Bored” could modify content to cross reference events with other events or times/dates. In an example, a college student could turn on the I'm Bored feature to find content regarding intramural sporting events for the day; a user could use the I'm Bored feature while looking at a music website to find links to shows scheduled for that day; or a user could use the I'm Bored feature to find events planned for that day at the public library; and so on.

There may be an addition/removal facility feature labeled “Teleport Me” that modifies content in certain content associated with geographical information. In an example, the Teleport Me feature could use an address or latitudinal and longitudinal coordinates in the target web page and/or a geomapping service such as, but not limited to, Google Maps, panoramio.com, or other map service to link the location to other content. Such other content may include, but is not limited to, options for traveling to the location, photos of the location, contacts at the location, maps of the location, landmarks at the location, site-seeing guides of the location, and other information about the location. The geomapping services could be used to find the coordinates that may be needed to link the information with the other content.

Alternatively or additionally, the addition/removal facility features may allow users to link to other users. The features could track users' presences in various online services such as, but not limited to, social networking websites and instant messaging applications. The presence of other users could be tracked by and displayed on the target page with links that include highlighting the person when that other user views certain content, linking to the other user when an event occurs on the content page, embedding instant messaging status in the page, and so on. In an example, a user could use the user linking feature to see when the user's friends view the user's weblog; a user could use the feature to see when the user's friends have logged into a website to play an online game; or a user could use the feature to see that the user's friend has logged into the friend's email 164 and read the last email 164 the user sent the friend; and so on.

Other content from other locations may be embedded into the target page using an addition/removal facility feature. Such content may include, but is not limited to, content from a paid service, content/service from a security service, content/service from a child protection service, content/service from a travel service, content/service from a social networking service, or some other content/service. In an example, a parent could use a service that removes links to adult content while the user's kids use the computer; a user could use a service that blocks suspicious or notorious websites while the user is shopping for mp3s online; an employer could use a sports news service to remove sports-related links from webpages while the user is at work; and so on.

Content may also be controlled by indices. These indices may provide control or augment control of linked content. The types of control that indices may have on linked content include, but are not limited to, quality control, control by relevance, security, control over sources of content, control of types of content 108, control of the performance of the content, and so on. Indices may also provide control of content by means of adding and/or removing content. Indices may inject code from different affiliates to associate content with the target page. Indices may add/remove content by implementing addition and/or removal index features.

An addition/removal index feature labeled “Keynote Fast” could modify content from contents/services that take longer than ten seconds to download. In an example, a user may turn on the Keynote Fast index when using a web browser on a mobile device with a slow internet connection; a user may use this index when traveling and using a pay-by-the-minute internet connection such as at Starbucks; a user may use the Keynote Fast index when trying to find the answer to the user's client's question quickly; and so on.

Another example is an index feature labeled “Websense Kids.” The Websense Kids index may modify content within the target page's content from sites with content that is not suitable for children. Such content may include adult content and other content not suitable for children. An existing service provider, such as Net Nanny may maintain the Websense Kids index that blocks content from sites with unsuitable content. In an example, a user could subscribe to the Websense Kids index and use it in the web browser the user's kids use to prevent them from viewing offensive or dangerous content.

A “Net Safe” feature index that modifies content from sites that present security risks is another example of a content control by index. A service provider such as McAfee that provides virus, adware, and other malware scanning services could maintain a Net Safe index. The index would then disallow content in the target page from sites with the malicious code. In an example, a user could subscribe to the Net Safe index service and use it so that when the user views web pages with content that has been flagged as containing malware, the content is removed for the user.

A content manager 130 may have a user interface 122. The user interface 122 may comprise a toolbar, a dialog box, a menu of modification features 112 with icons, and the like. One or more icons may represent each modification feature. In one example, a plus-sign icon may represent a feature that allows users to add hyperlinks 192. The modification features may be stored in a features database. The menu may be presented by a web browser, a web page, a word processor, an RSS reader, an email 164, an instant message, any other computer user interface 122 program (Desktop application), an operating system, such as but without limitation, Windows Explorer, and the like. The menu may be persistently displayed or may be displayed by selecting content. In an example, a user interested in adding hyperlinks 192 related to do-it-yourself wiring projects to the Amazon.com Tools & Hardware category web page may access the content manager 130 through a user interface 122 activated when the user right clicks on any existing links, such as the Home Improvement featured category.

The content manager 130 may be connected to a features database. The connection between a feature or a feature button and a database 162 may persist so that the user or another party may change the feature or feature button. In an example, a user may specify that a compare feature that inserts or removes content related to price or product/service reviews be activated whenever an eBay webpage is accessed. While the feature 102 may have initially operated on name similarity in locating hyperlinks 192, the persistent link may allow the user to modify the feature some time after its initial activation to include searches for ISBN, EAN codes, UPC codes, microformats, or other markups in locating relevant hyperlinks 192.

The content manager 130 may be associated with methods 110 of generating, adding, modifying, and/or removing features. In one example, when the features 102 database is downloaded from a server or transferred from another source 120, commands may be generated on a client through client software, by a web service, by another service, and the like. In another example, a user requiring a feature 102 not present in the features 102 database (such as but without limitation a feature 102 that automatically calculates shipping costs for a product) may author the command associated with the feature 102 and add it to the features 102 database. When the features 102 database resides on a client, a user's client, or some other computing device, commands may be received from a third-party database or transferred to a third-party database through instant messaging, electronic mailing, text messaging, a voice-over-IP message, and the like. In still another example, a feature 102 that automatically calculates shipping costs may be received from FedEx.

The content manager 130 may be associated with methods 110 for automatically generating HTML widgets to facilitate the spread of features 102 and buttons. In an example, the content manager 130 may generate an HTML widget any time a new feature 102 is added to the features 102 database. A user may access the HTML widget to learn about the new feature 102. Optionally, the HTML widget may act as or provide access to a user interface 122.

The content manager 130 may be associated with methods 110 for creating dynamic hyperlinks 119. The methods 110 may include a system that creates the hyperlinks 192, a model for creating the hyperlinks 192, facilities for creating the hyperlinks 192, other methods 110 for creating the hyperlinks 192, and the like. In an example, a user may access the content manager 130, optionally through a user interface 122, and specify that whenever an eBay auction web page is accessed, a set of hyperlinks 192 to other similar products should be generated dynamically and inserted into the web page when it is loading or while it is loaded.

The content manager 130 may allow user control of the hyperlinks 192 in order to control web navigation. Control of the hyperlinks 192 may be granted to the authors of the website, the publishers of the website, content creators for the website, individual users of the website, user communities that use the website, and the like. In an example, Target.com may be given control of dynamically-generated hyperlinks 192 associated with a product sold on their website in order to further rank the displayed hyperlinks 192. In another example, a user may be given control of dynamically generated hyperlinks 192 that are associated with a product so that whenever the user views that product on a website those hyperlinks 192 are displayed along with the product.

The content manager 130 may transform a static set of hyperlinks 192 into a dynamic set of hyperlinks 192 and/or identifiers. In one example, when a user accesses a social networking website such as a MySpace user web page containing static links to various bands' web pages, the content manager 130 may transform the static links into dynamic links to content associated with the bands. The hyperlinks 192 may be adapted based upon an association with a domain. In another example, when the content manager 130 comes across the text ‘1644’ on a webpage the content manager 130 may determine whether the webpage is associated with a movie domain, a music domain, or a book domain. Based upon the domain, the content manager 130 may associate the text ‘1644’ with a dynamic link to an electronic copy of the book by George Orwell; to a page full of links to some homepages for bands that are named nineteen eighty-four; or to a digitized version of the 1956 film adaptation of the Orwell book featuring Edmond O'Brien as Winston Smith.

A user may set a preference, desire, and/or specification that may be used to adapt hyperlinks 192. In an example, a user may set a preference specifying that when static hyperlinks 192 on a MySpace web page are dynamically modified, the resulting hyperlinks 192 should point to relevant content on Wikipedia. The ability to transform or modify the hyperlinks 192 may give the user and/or user group the control or additional control over the quality of hyperlinks 192, relevance of hyperlinks 192, security of hyperlinks 192, quantity of hyperlinks 192, sources of hyperlinks 192, types of hyperlinks 192, performance of the content linked to or excluded from the hyperlinks 192, the manner in which content is linked to or excluded from the hyperlinks 192, and the like.

The content manager 130 may be associated with the creation of alternative web structures. Possible creators include without limitation users, communities, merchants, vendors, service providers, content providers, and the like. Alternative web structures may be used in e-commerce, online auctions, web searching, web advertising, and the like. Alternative web structures may allow web searching enabled by mash indices. A mash index may be an active map of the current content. A user, a web service provider, and the like may create the mash index. The mash index may map words to specific URLs or other location identifiers. The type of content 108 mapped may be files, music, streams, videos, and the like. In an example, a user may create a mash index including the phrase ‘World War I’ which may be mapped to a listing of related books on Amazon.com, related paraphernalia on eBay, related movies on imdb.com, and the like. Mapping of content may occur in context. Mapping of content may account for contextual parameters and data. Searching may be done at the level of the elements and/or content of the index, type or classification of the index, and the like. In an example, a user may search the internet conventionally for ‘Malaysia’ and retrieve search results related to the CIA World Factbook on Malaysia, a national tourism page, the Malaysia Airlines website, and the like. However, should the same ‘Malaysia’ search be enabled by a mash index created by a user, the search may return, in addition to or in place of the conventional search results, a link to a Southeast Asia travel blog, a link to the Penang restaurant chain in New York, Massachusetts, Pennsylvania, and Washington, D.C., a link to a local university's Malay language class, and the like.

The content manager 130 may manage content whose source code is open source or proprietary. Open source describes practices in production and development that promote access to an end product's source code. The open source model can allow for the concurrent use of different approaches in production, in contrast with more centralized models of development such as those typically used in commercial software companies. In contrast, products with proprietary source code are produced, developed, and distributed in such a way that the original code is not widely available to the end-users or other developers. The content manager 130 may manage content that is either open source or proprietary by providing hyperlinks 192 to other programming resources. In one example, such resources may include the definitions of functions, libraries, procedures, or the like; updates to the libraries referenced in the code; alternative resources to those used in the source content (e.g. open source libraries to replace proprietary libraries); the work and/or personal weblogs of the libraries' authors; programmer's group discussion on the source code (e.g. in Google Groups); guides on best practices for using the library, language, or API used in the content; and so on.

The content manager 130 may be associated with a method 110 of redefining the structure of the web or a subset of the web, such as and without limitation by changing the links within webpages. Redefining the structure of the web may be associated with user-defined preferences, user group-defined preferences or specifications, user-defined preferences or specifications of a separate user, third party defined preferences or specifications, and the like. The types of creators of structures for a user include the user themselves, another user, a user group, a third party, and the like. The creator of a structure may grant or deny permission for other users to use the structure.

The content command database 128 may be distributed, shared, duplicated, linked, cached, and/or be propagated to the user by various systems and methods. These different ways for propagating the content command database 128 may allow for multiple ways of propagating the features 102 or commands contained in the database 128. Regardless of how the database 128 is accessed and propagated to the end user, it may be stored in various ways. The database 128 may be stored on a client, a user client, a server, a hard drive, temporary memory (e.g. RAM), removable media (such as and without limitation, a floppy disk, a jump drive, a CD, a DVD, a removable flash memory), another type of data storage facility, and the like.

A distributed database may encompass a database where the parts of the database are stored on separate storage devices which may or may not all be attached to a common CPU. Without limitation, the parts of the database may comprise the database tables, records, partitions, procedures, other structures, and the like. A distributed database may be stored in multiple computers located in the same physical location or may be dispersed over a network of interconnected computers. Since the data is distributed across multiple physical locations as separate partitions/fragments, the fragments may be used as redundant copies of each other. The fragmentation of the database data allows the database to be synchronized from a central database management system (DBMS) while also allowing for local autonomy over the individual fragments. For the content command database 128, the redundantly distributed copies may be modified and personalized by the users who possess them. The synchronization process may be controlled by the original database from which updates to the features 102 can be pushed to the distributed copies.

Shared databases have multiple users connecting to the same DBMS. Though the users connect to a central DBMS, the data may reside in partitions/fragments in a distributed database. Since the DBMS is where the users get the features 102, updates to features 102 or additional features 102 only need to be made in the DBMS and when the user reconnects to it, the user can use the new or updated feature.

A duplicated/replicated database may encompass two or more databases that are more or less identical copies of each other. When an update is applied to one of the databases, that change may automatically be applied to the other copies so that all of the copies remain identical or at least tend to converge over time. In embodiments, a client, server, or component thereof may download a copy of the replicated database so as to maintain a local copy of the database. It will be appreciated that maintaining a local copy of a database will, in some circumstances, offer advantages as compared with utilizing a centralized or remote database. In an example, a local copy of a database may be more rapidly accessible and/or more highly available than a remote copy.

A linked database is a database that points to data in another source database. The links between databases may be static or dynamic. The static links point to the data in a source database and the links do not depend on any input. The dynamic links point to data in a source database, but the links may point to different data or a different database, perhaps depending upon input at the time that the link is used. The linked database may be stored remotely or stored locally and the source database may be stored at a third location or any other location. In an example, a user may download, from an author of a feature, a linked database that statically links to the source database that the author maintains.

A cached database is stored temporarily. The cached database may be stored in various locations including, but not limited to, the user's local machine, a server or another location. In an example, a user may visit the website for a certain feature, the user's browser may download a temporary copy of the database and store it in a temporary location on the user's machine, and, when the user's temporary files are deleted (e.g. when the web browser closes or when the cached database file(s) expire) the cached database file would be removed from the local machine.

Embodiments of the present invention may implement methods 110 of operation that include modification, action, and other operational methods 110. The modification method 110 may be associated with generating a user presentation that encompasses a modification of content from a content source such as a web page, a document, a database, an instant message, a text message, a video broadcast, and the like. As a result, the user presentation (such as and without limitation a display of a web page of a web site) may be modified by way of applying one or more modification features 102 and/or content commands prior to or contemporaneously with presentation to the user.

The modification method 110 of operation may be invoked automatically (such as and without limitation when a web page is presented) or manually (such as and without limitation by a user clicking on a menu feature). Other aspects of invoking the modification method 110 of operation may include schedule based, event based, and content based triggers or signals. Since a result of the modification method 110 of operation is modified content, the user presentation of source content may be modified in a variety of ways including content, formats, appearances, and the like. This may allow a user to select one of the varieties at any time for presentation. The presented variety may be based on one or more of the modification features 102 selected, the content commands applied, the source content, and other factors herein described. A user may select a menu feature 112 that results in the originally sourced content being displayed without modification.

A user menu feature 112 selection, for example clicking a menu item from a user interface 122 display menu, may display a web page or redisplay an already displayed web page that is modified by elements of the content manager 130. The menu feature 112 selection may provide input, commands, or other modification direction to the content manager 130. In an example, a menu feature 112 selection may provide a reference to a portion of a content command database 128 that includes modification commands, cross references, table lookups, substitutions, rules, and the like to the content manager 130.

The menu feature 112 selection may translate into a command directed to the content manager 130. In an example but without limitation, the menu feature 112 may be selected from a pull down menu or other user interface 122 selection such as a radio button, a command line input, an icon, and the like. The pull down menu may be presented and controlled by a software program such as a web browser plug-in that may distinguish the specific feature selected so that a specific command or set of commands are provided to the content manager 130 for implementing the selected menu feature. The command or commands may be software variables passed from the menu feature 112 software to the content manager 130 software. The content manager 130 may receive the variables and further process them.

Processing the variables, commands, references, and other input as herein described, may result in the content manager 130 referencing a content command database 128 that may contain specific commands or instructions for modifying content. As an example but without limitation, a menu feature 112 selection may result in a command to the content manager 130 to access content commands in the content command database 128 to display foreign currency in source content as US dollars. The content manager 130 may retrieve a set of conversion tables from the content command database 128 that facilitate the conversion of foreign currency to US dollars. The content manager 130 may add the US dollars content and remove the foreign currency content for presentation to the user. As exemplified above, content commands may include modification instructions for adding and/or removing content.

Specific modifications performed by the content manager 130 may be with respect to other content. In the foreign currency conversion example, instead of using a set of conversion tables referenced in the command content database 128, the content command database 128 may include a link to a currency conversion website that may have more up-to-date conversion rates.

Content commands may be directed at adding content. Content may be added to a presented web page, a document, or any user presentation of content. Added content may be static, such as a header that includes a corporate logo in a business application; it may be dynamic, such as a timer that displays the amount of time a user views the content; it may be conditional, such as displaying the number of times a user has accessed the content; and so on. Adding content may be based on one or more aspects of the content source, such as the language of the content, the web site of the content, the date of the content, the title of a document, metadata associated with the content, and the like. In an example but without limitation, a menu feature 112 selection may result in a content command adding a list of links to sites that offer services related to a product referenced in the source content.

Content commands may be directed at removing content. Content may be removed, effectively preventing the content from being presented to the user. A popular benefit of removing content is parental control. By selecting a menu feature 112, or automatically invoking the content commands associated with the modification feature 102, a parent can prevent certain content from being presented to a user such as a child. Removing content may also provide benefits of faster display of the modified content. In an example but without limitation, background images that increase content display time may be removed. In another example but without limitation, content such as advertising banners that flash or are considered annoying may be removed.

Content commands may be directed at placing content. Content may be placed in relationship to other content, relative to a location on a web page, relative to a user presentation device, and the like. Placing content may provide a preferred order for content lists, or may include placing banner advertisement or other click advertisements at a bottom of a webpage, thereby reducing content presentation clutter. In an example but without limitation, a menu feature 1120 may be selected to direct the content manager 130 to display any “contact us” and any “help” content or links in the upper left hand corner of a web page.

Content commands may be directed at references to content. Content references may be within the source content, related to the source content, related to the content being referenced, or any other reference to content. Content references may be related to categories of content, such as and without limitation political parties (Democrat, Republican, and Libertarian). Content references may be related to news headlines, movie stars, performers, sports personalities, professional sports, and the like. Content may be placed based on its reference. In one example, content that references Britney Spears (e.g. her name, her husband's name, her song titles, and the like), may be placed in a preferred position for presentation to the user. In another example, content that references the Democratic Party may be placed together with other political party content references.

Content commands may be directed at links to content. In addition to adding and removing links, content commands may process links so that the linked content may be used when modifying the source content. In one example, links in source content that provide further detail about a content item may be accessed so that the further detail is displayed in the modified content. Alternatively, such a link may be augmented to include a link to a user preferred Wiki such as Wikipedia, thereby allowing the user to access preferred detail or definitions. Content commands may also be directed at removing redirection within a link. In another example, a link to an article about Cape Cod may redirect a user through an advertiser website, resulting in advertisements from that advertiser appearing on the Cape Cod article. These links could be modified to direct navigation toward a user's preferred advertiser or to no advertiser at all.

Content commands may be directed at size of content. Size of content may include a byte count of a web page, byte count and/or resolution of images, byte count of a document, and other measures of size of content. Size of content may be precise or estimated (such as may be the case for streaming content and the like). Size of content may include source content size, modified content size, and the like. By directing content commands at size of content, large size content that may slow down presentation of the content or may require a long time to process by the content manager 130 may be detected. The detection and actions taken based on content size may be determined by content commands. In an example and without limitation, content that is above a predetermined size (e.g. 1 MB), may only have the first 100 KB processed by the content manager 130 before presenting it to the user and the additional content can be processed after the first 100 KB are displayed. This may improve a user's perception of system performance.

Content commands may be directed at color of content. Content command modifications may be based on source content color or may be directed as modifying content into a specific color. Content may be modified so that it fits into one or more color schemes. In one example, yellow text may be difficult to see, so a user may invoke a content command to modify yellow text content into black text content. Such a modification may be accomplished by changing a reference to color in the source content file before it is presented to the user. In another example, content that references Democrats may be displayed in blue and all content that references the Republicans may be displayed in red. In yet another example, added content may be presented in a color that is different from original content. Many other examples will be appreciated and all such examples are within the scope of the present disclosure.

Content commands may be directed at multimedia effects of content. Multimedia effects of content may include any changeable aspect of content such as content color, blinking, images, visual transitions, presentation timing, and the like. Content commands directed at multimedia effects of content may include adding, removing, modifying, or halting a multimedia effect. Content with certain multimedia effects, such as rapid blinking, may be removed. Multimedia effects may be added to content so that static source content may be visually or audibly highlighted. In an example, content that can be associated with a sound, such as a dog barking, may be modified so that selecting the content or moving a cursor over the content may cause the sound to be generated.

Content commands may be directed at timing of content. Timing of content maybe relative to other content, relative to a standard, relative to a user preference, relative to a learned value, or any other measure or aspect of timing. In an example, content that changes download rate dramatically may be identified by content commands directed at timing of content. Content commands may also modify the order of presentation of elements of the content to a user so that content (such as and without limitation an advertisement) is presented after other content. Links to slow-downloading content may be removed by the content manager 130 and replaced with links to faster-downloading content. Content timing may be related to date and time metadata associated with the content. Content commands may be directed at content based on content date and time. In another example, content that is older than a preferred date and/or time may be removed.

Content can be viewed in a variety of ways. Therefore, content commands may include multiple structures mapped to the same content, text, word, image, or concept. The structures may affect different aspects of the content and therefore may be applied simultaneously to the content. An example may include adding multimedia features and converting foreign currency. However, these structures may need to be prioritized if they modify content in incompatible ways (such as converting to US dollars and Euros, removing and adding sound, and so on). To support multiple structures mapped to the same content, a prioritization scheme may be applied. An objective of the prioritization scheme may be to disambiguate the resulting modification.

Prioritization of content command structures may be based on user preferences. User preferences for prioritization of content command structures may be based on explicit preferences input or selected by a user, may be implicitly determined, and so on. Implicitly determined user preferences may be derived from examining user past performance, other user preferences, and the like. In an example, content commands may result in different links being added to the text “Tundra”. A user may explicitly prefer a link to Wikipedia over links to automobiles or links to geography. In this situation, the user-preferred link to Wikipedia would be added to the content.

Prioritization may be based on one or more aspects of the context of the user environment. Aspects such as current user activity, user device, user location, user connection speed, and the like may impact prioritization of content command structures. Prioritization of content command structures for “Tundra” may be different when a user is researching the North Pole than when he is researching automobiles. Prioritization may be based on a domain of the source content. The domain of the source content may imply a certain context for the content that may facilitate selecting one of the multiple of content command structures. In one example, source content from domain www.toyota.com may result in links related to the Toyota Tundra being added to content that includes “Tundra”.

Prioritization may be based on one or more weights of modification features 102, content commands, and the like. A user, a content provider, or the like may specify weights based on the order in which the modification features 102 are added to the system or according to any and all other schemes for specifying weights. Weights may include any and all forms of differentiation that facilitate a predictable ordering of some elements that are being weighted. In one example, weights may include numerical values with higher numerical values having more weight so that a modification feature 102 or content command with a higher numerical value would be prioritized over a modification feature 102 or content command with a lower numerical value. Weights may be applied to more than one aspect of a modification feature 102 and/or content command. Priority may be based on a combination of weighted aspects or on a subset of weighted aspects. In an example, modification features 102 may have weights assigned to the source 120 of the feature. A source 120 weight may be higher for a user generated or configured feature than a third party sourced feature. As a result, modification features 102 or content commands that are user generated may be prioritized over third party content commands or structures that map to the same content.

In addition to the various prioritization schemes described herein, content command structures may be organized into a hierarchy or sets of hierarchies to further facilitate content modification meeting user expectations. A benefit of organized hierarchies is that they can be saved by a user and recalled. A user may save a hierarchy associated with shopping for anniversary gifts and recall the hierarchy each year. Hierarchies may be shared among users so that users may benefit from other's content command structure organization. Sharing of hierarchies may be done through publishing, email 164, any and all forms of electronic transfer, any and all forms of file sharing, through P2P networks, and the like. A hierarchy may be stored locally on a user's computer or may be stored remotely such as on a network server. More than one user may access a shared hierarchy such as a hierarchy stored on a network server or a shared file directory on a user computer. Modification rights to shared hierarchies may be controlled by any of a variety of file access rights methods 110 applied in file sharing systems including, without limitation, password protection, user and group protection, local vs. remote access, role-based access, cryptographic-key-based access, and the like.

An order of content command structures within and across hierarchies may be ordered by default or based on content for purposes such as shopping, advertising, investing, web searching, gaming, research, dating, working, web surfing, fund raising, and so on.

An alternate method 110 of operation may include an action method 110. An action method 110 may be distinguished from a modification method 110 in a variety of ways. One differentiation may include the presentation of content. While a modification operational method 110 modifies content for presentation to a user, an action method 110 may not impact presentation of content to a user. Instead, an action method 110 of operation may take input from a user, such as content selection, and may apply content commands that may result in content modification, content display 124, navigation, and the like. While a modification method 110 may modify content such as adding links to content and presenting the modified content to the user, an action method 110 may dynamically interact with the user's interaction with the presented content. As an example and without limitation, a user may pause the cursor over the word “Tundra”. An action method 110 may detect the paused cursor and may apply content commands and display a pop-up type window related to “Tundra”. In addition to acting when a user pauses a cursor, a user may select content, such as a word (or sentence, paragraph, title), an image, an icon, or any content item. The action method 110 may apply content commands to the selected content resulting in new information being displayed such as in a pop-up window, a drop down menu, or in place of the selected content. In an example of content selection action 114 method 110, when a user selects an image of a company logo, the user would be presented with a website of the company or related to the company. Selecting an image of the Boston Red Sox may result in the official website of the Boston Red Sox being presented to the user.

The action method 110 may allow a user to view source content without modification yet receive the benefit of the content modification platform 100 as the user interacts with the content through a user interface 122 program such as a web browser, text editor, graphic drawing program, music play list, and the like. The action method 110 may also allow a user to dynamically create content commands, modification features 102, and hierarchies by presenting to the user alternatives as the user interacts with the presented content. A user may choose from a plurality of links related to selected content that are presented to the user. In this way a user may customize a content command structure provided by a third party, another user, and the like.

The action method 110 of operation may include adding content, removing content, adding links, removing links, and all other modification features 102 and content commands as herein described for the modification method 110 of operation.

The method 110 of operation may also be invoked and or disabled by a user, automatically, by an ISP, by a firewall program, and the like. In this way, the modification method 110 of operation may be invoked to meet requirements such as confidentiality, regulatory statutes, and the like. A user may specify that modification features 102 and/or content commands may be invoked or disabled for specific content, for a specific web page, for a specific document, and so on. A user may wish to invoke the modification method 110 to a specific document when the document is viewed by non-authorized users and may wish to disable it when the user views the document. Invoking and/or disabling the modification and/or action method 110 of operation may be per program session. In an example, when a user accesses email 164 at a customer location, the user may wish to invoke a modification feature 102 that removes references to other customers in displayed email 164s. In this way a user may retain confidentiality of customer information. A user may use a computer's desktop user interface 122 to invoke the modification features 102 and/or content commands for any desktop program such as a word processor, a graphic editor, a multimedia playing program, and the like.

Content commands may be automatically invoked based on aspects of the user environment. In an example, a user may be using a computer at an airport kiosk to access files through the internet. The location of the user may be detected (such as by the IP address of the kiosk) and, in response to this, content commands may be invoked automatically.

A corporation, enterprise, individual, or other entity may configure a firewall to invoke content commands and/or modification features 102. This configuration may cause the firewall to apply the content commands to some or all of the content passing through the firewall. In an example, enterprise-wide rules may apply to the presentation or transmissions of competitor links, industry links, client/customer links, IP filtering, trademark filtering, and the like. According to the configuration, the firewall may invoke the content manager 130 to process outbound content such as email 164, attachments, and the like so that content commands may be applied to remove sensitive information such as client lists and the like.

Internet service providers (ISPs) may take advantage of the modification features 102 and content commands to comply with regulatory statutes, ISP corporate standards, and the like. An ISP may apply content commands so that they may stop the transmission of copyrighted content that does not comply with digital rights standards. An ISP may use the link removal 140 and addition 1380 features 102 of the modification method 110 of operation to redirect links to copyrighted material to the copyright owner's site.

The content modification platform 100 may provide methods 110 for modifying the functionality of the platform 100. These methods 110 may include user-executed modifications. In one example, a user may modify a feature that inserts new hyperlinks 192 to a web page to include the ability to populate a comment field for the inserted hyperlinks 192. The functionality may be associated with and/or encompass a feature or a feature button. A feature's creator or any and all other users may propagate a modification to the functionality. In an example, a user may receive from FedEx a web-based feature that automatically calculates shipping costs, which FedEx may further update to include a new packaging option. Modifying the functionality may further comprise creating a personalized, edited version of another's feature or construction; an edit of another's index, which may require permission; and the like. In another example, a user may modify FedEx's feature for automatically calculating shipping costs to always populate with certain defaults when activated, such as origin address and insurance limits. Changes to a feature, feature button, index, order, or hierarchy may be published to other users. In an example, a user may receive changes to a feature when they refresh or restart their web browser.

The following descriptions of content and environments exemplify categories that may be user configurable through modification features 102 and may be modified by or linked through content commands. A menu of modification features 112 may be configured for each of the following, for combinations of the following, and for any other type or source of content 108. Content commands and other databases herein described may associate one or more of the following to one or more other of the following without limit. While some examples of modification, association, and linking are described below, many other combinations will be apparent and therefore are included in embodiments herein.

Included in these examples, and as may be applied to any content or environment, media types may include data, e-books, images, video, slide shows, music, maps or other spatial representations, and the like. In any and all examples herein, and any other content or environment, more than one media type may be applicable. Also, modification features 102, menus 112, content commands, and other aspects of the content modification platform 100 may include or provide support for other media types not herein described.

Media content and/or media environments may benefit from aspects of the content modification platform 100. Media content and/or media environments may include a variety of actions that a user or automated system may take that may be associated with the media. Media content and/or media environments may be associated with a variety of other types of content 108 that may, for example facilitate e-commerce related to the media, or may enrich a user's experience with the media. Searching for media, such as on the web, an intranet, within a peer-to-peer network, within a virtual media store, and the like may be one type of action. Media sharing through file sharing, transferring, sampling, peer-to-peer network sharing, and the like may be another type of media action. Users of media commonly submit reviews, comments, recommendations, and other input related to the media. This input may be done through a response form of a media related website, a questionnaire at a media store, a questionnaire mailed, a unstructured response submitted through the mail, entries in blogs, and any other form of electronic communication. Media may be downloaded for use or may be streamed for presentation such as viewing or listening to the stream through a multimedia equipped computing facility or game 101. Creators, editors, promoters, managers, and any other individual, group, or entity associated with media may post media (e.g. to a website). Media may be posted, distributed, streamed, downloaded, and used (e.g. viewed or listened to) with our without digital rights management. Users and/or automated systems may combine, edit, remix, mash, compile, translate, and the like media to meet a particular need, preference, or marketing objective. Media may include or be associated with metadata. Metadata may be attached to or imbedded in the media. Digital watermarking may also be applied to media. Users may buy, rent, donate, purchase, license, subscribe to, use pay-per-view, and apply any other form of trade or exchange with media. Media may include or be associated with advertisements (e.g. an advertisement promoting the purchase of a full recording of a sample presented to the user). Media may be stored, such as persistently on storage like CDs, DVDs, tape, vinyl, and any type of persistent storage. Business may be associated with media. In addition to e-commerce of the media, concerts, performances, interviews, fan clubs, professional reviews, awards presentations, and a wide variety of business may be associated with media. Media may be conveniently configured or organized into categories, genres, folders, and the like. Media may be organized through the use of tags. Organization may be based on explicit aspects of the media such as media type, or on implicit aspects such as genre. Organization may also be based on user preference or rating.

Presentation of media to a user may be enriched through presentation of additional content. In an example, content commands may be applied to a movie so that the presentation of the movie may be modified to include a text overlay of relevant information about the media such as notes from the director. Viewer comments about scenes in the movie may be sourced, such as through an automatic search of the internet, and presented along with the movie. A modification feature 102 may be configured for media that modifies the audio presented so that foul language is removed. A modification feature 102 and content command may be configured for media that replaces a character name in the presented audio with a name selected by the viewer.

Auctions, classified listings and/or their environments may benefit from aspects of the content modification platform 100. Auctions, classified listings and/or their environments may include a variety of actions that a user or automated system may take. Auctions, classified listings and/or their environments may be associated with a variety of other types of content 108 that may, for example facilitate e-commerce related to the auctions or classified listings, or may enrich a user's experience with the auctions or classified listings. Users and/or automated systems may search auctions or classified listings for items of interest or value. Searching may be targeted at finding an item available through the auction or classified listing that meets a criteria that is important to the user such as price, location, quality, time remaining, time listed, and the like. Users may browse (e.g. visual searching) auctions or classified listings. Browsing may include one or more of viewing, touching, listening, feeling, smelling, and the like items available though an auction or classified listing. Users may bid for an item available through auction and may purchase (e.g. buy now) an item available for purchase through an auction or classified listing. Similarly users may ask (e.g. offer for sale) an item through an auction or classified listing. Offering for sale may be accompanied by posting an item for sale. Selling and/or buying through an auction or classified listing may be performed through a one-click e-commerce transaction. Another action related to auctions and/or classified listings is analysis of information, statistics, pricing, market research, transaction history, fulfillment history, return history, product ratings, seller ratings, buyer ratings, and the like. A seller reputation, as determined by user ratings, transaction statistics, quality measurements, and the like may include input by buyers of that seller. Associated with auctions and/or classified listings is shipping and delivery of items such as trucking of a physical item and downloading of an electronic item. Payment and payment systems, including banking and other financial transaction systems may be associated with auctions and/or classified listings.

In an example, a modification feature 102 may be configured and associated with auction and/or classified listings so that shipping charges may be presented to the user in an auction or classified listing based on the source and weight of the item. Alternatively, a source address in an auction or classified listing may be linked to a listing of shipping options.

A business user participating as a bidder in an auction may desire to have available other information to facilitate bidding. The information may include current inventory of an item available through the auction, projected or committed delivery schedule of the item from other suppliers, costs of the inventory and any orders, approved vendor or other required information about an item. This information may be linked or associated with an auction or classified listing item presented to a user by applying a modification feature 102 and/or content command thorough the content manager 130 of the content modification platform 100. As herein described, the information may be added to the auction content before being presented to the user.

Business platforms and/or business environments may benefit from aspects of the content modification platform 100. Business platforms and/or business environments may include a variety of actions that a user or automated system may take that may be associated with the platform or environment. Business platforms and/or business environments may be associated with a variety of other types of content 108 that may, for example facilitate e-commerce, or may enrich a user's experience with the platform or business environment. Business platforms include education, research, scheduling or calendar use, word processing, spreadsheet calculations, presentations, contact and client management, mail such as email 164, messaging, document management, workflow management, project management, compliance with standards and regulations, human resources, supply chain, databases, collaboration tools, accounting, finance, sales and marketing management (e.g. sales tools).

A human resource platform may benefit from the content modification platform 100 to facilitate preserving confidentiality. In an example, a modification feature 102 may be configured to remove any employee name or other personal information from the presentation of a personnel file. A content command and database 128 may be configured with an employee list and/or employee confidential information that may be removed by the content modification platform 100. Also within the human resource platform, a modification feature 102 may be configured to add links to employee home phone numbers and/or addresses in a secure presentation of an employee list so that the source employee list can be made available within the company without the home information.

E-commerce may benefit from aspects of the content modification platform 100. E-commerce may include a variety of actions that a user or automated system may take that may be associated with the e-commerce. E-commerce may be associated with a variety of other types of content 108 that may, for example facilitate product rating, or may enrich a user's experience with e-commerce. Goods and services may be purchased, leased, rented, licensed, transferred, and otherwise transacted in an e-commerce environment. E-commerce may serve transactions of digital items (e.g. databases, games, music files, e-books, documents, email 164) and physical items (e.g. shoes, clothing, toys, automobile tires, and the like). Advertisements, promotions, discounts, and the like may be included in or be the subject of e-commerce. E-commerce may be embodied in digital transactions between individuals, entities, businesses, groups, foundations, financial institutions, suppliers, and any other person or facility capable of performing a digital transaction. These digital transactions may facilitate business-to-business e-commerce, business-to-consumer e-commerce, consumer-to-consumer e-commerce, and the like. Information may play a vital role in e-commerce. Information such as supply chain information, payment information, tracking information, and the like may be included in or associated with e-commerce. An aspect of e-commerce is fulfillment of the e-commerce transaction. Digital fulfillment may be executed by downloading a digital item. Physical fulfillment may be executed by distribution, shipping, and tracking services. E-commerce may facilitate integration of on-line and off-line commerce such as a website that offers a discount coupon to an off-line in-store transaction for completing an on-line e-commerce transaction. An off-line location may utilize an on-line e-commerce system to complete transactions such as credit card purchases, and the like. E-commerce may include methods 110 to facilitate payments. Managing accounts such as tracking purchases may be performed through e-commerce. Searching may facilitate selection of an item, service, good, vendor, service provider, and the like that may be included in or be a party to e-commerce. Consumers, regulatory agencies, law enforcement, and others may establish rating systems and methods 110 associated with e-commerce. They may review products, services, B2B suppliers, B2B buyers, B2C suppliers and/or buyers. Users may use this and other data related to e-commerce to make comparisons that facilitate selecting among the available choices. E-commerce may be embodied as an on-line form of shopping. Shopping may include manual shopping activity, automated such as on-line “bots” that automatically complete an e-commerce transaction according to a set of criteria, and spiders or web crawlers that identify and rapidly present e-commerce options based on a criteria or user preference. In addition to purchases, e-commerce may include returns, exchanges, repairs, and managing back orders of non-inventory items.

E-commerce advertising, such as a discount promotion, may be combined through a content modification platform 100 with business platforms such as workflow management. A workflow planning system may present to a planner the option of selecting an alternate workflow based on availability of a discount or promotion. In an example, a planner may have the option of scheduling a certain task in the workflow, such as purchasing raw material needed for a subsequent task in the workflow. The planner may configure a modification feature 102 to include, within a workflow planning system/user interface, links to all available promotions associated with raw materials to be purchased. The planner may select one or more of these promotions and adjust a workflow to accommodate the promotion. Without the promotion related information (e.g. links in the workflow plan), the planner may schedule work that is eligible for the promotion during a time when the promotion is not active.

Games may benefit from aspects of the content modification platform 100. Games may include a variety of actions that a user or automated system may take that may be associated with the games. Games may be associated with a variety of other types of content 108 that may, for example facilitate game rating, or may enrich a user's experience with games. Games may be grouped or otherwise identified with categories or types. Categories and types may be based on an aspect of the game such as the appropriate minimum user age, the level of competition, the language, and the like. Games may include wagering. On-line betting, gambling, lottery, and the like may be games. Within a game, such as poker, a user is required to wager to participate in the game. Alternatively, games may not include wagering. Games such as crossword puzzles, and the like may be played without requiring or offering the user to wager. A user may play a game that is part of a subscription the user may have purchased or ordered. The subscription may include the option of playing a variety of games available through the subscription, or may be for use of a single game during the subscription period. Games may be advertisement supported so that users may play a game for free. Advertisement supported games may include visual or audible advertisements shown concurrently with or interspersed with rounds of a game. Solo games, such as solitaire, crossword puzzles, and the like may be available and played on-line, off-line, and standalone. Similarly multiplayer games may be played on-line, off-line, or through a local network of players. Games may also be downloaded to the user gaming console, computer, and the like. The platform (user device) through which the user plays the game may affect aspects of the game such as the number of players, the complexity of visual presentations, the cost, and the like. A game played on a mobile phone may include a very different user interface 122 than the same game played on a gaming console or a computer with a large display monitor. Incentive games may include a reward for winning. The reward may include points that may be accumulated and used toward other rewards such as additional playing time. Games may include community or social aspects such as allowing gamers to interact through a chat window of the game. By including a social networking component, games may provide a meeting place for users. Users may play games that normally include a risk of financial gain or loss for charitable purposes. Users playing games associated with a casino, may select to have some portion of the proceeds of their playing (their winnings, their loses, or both) be directed toward a charity. Users and other gamers may develop rankings of games. Rankings may be based on any aspect of the game such as the length of time required to complete the game, the quality of the presentation, the reliability of the game, and the like. Rankings, ratings, comments, evaluation, and other commentary about games may be included in any form of electronic communication, electronic publishing, or other content such as game newsletters. On-line virtual existence games may include virtual life aspects as well as solo and multiplayer gaming. Users may create on-line or game persona that may disguise or otherwise be different from their actual persona.

Games and gaming may benefit from the content modification platform 100 and may be combined with other aspects associated with content such a player device type. A user may be downloading free games on a computer, but may intend to play them on a mobile communication device such as a cell phone. The user may configure a modification feature 102 of the content modification platform 100, to link instances of any game in content presented on the computer screen to downloadable versions that are compatible with their cell phone. In this way, the user may download the cell phone compatible versions to their computer for subsequent upload to their cell phone.

A user may be playing an action game that includes presentation of individual characters in the game. The user may want to integrate instant messaging with the game and may configure a modification feature 102 and/or content command to facilitate the integration. In an example, the user may configure a content command that inserts instant messages to the game content as if the messages were being spoken by a character in the game.

Marketing or advertising may benefit from aspects of the content modification platform 100. Marketing or advertising may include a variety of actions that a user or automated system may take that may be associated with marketing or advertising. Marketing or advertising may be associated with a variety of other types of content 108 that may, for example facilitate e-commerce, or may enrich a user's experience with marketing or advertising. Pop-ups, for example may be part of a marketing or advertising strategy to reach potential new customers. Similarly, alerts, notification, email 164, sponsored calls, instant messages, text messages, FAX, and the like may be included in a marketing or advertising campaign. Visual, audible, or both visual and audible presentation, such as a dynamic ticker displayed on a user monitor may include or be a method 110 of delivering marketing or advertisements. Marketing and advertising may include icons designed to meet a particular marketing or advertising objective. A user cursor or pointer may be dynamically changed based on a marketing or advertising objective. Advertisements and marketing messages may be embodied as sponsored links, banners, dynamic advertisement insertions, and the like. Advertisements may comply with a pay-per-click accounting and fee method. Similarly, affiliates may agree to provide advertising or marketing services so that they may gain access to new and existing users. Affiliates may also offer goods and or services related to an advertised item that facilitate expanding the marketing footprint of a more conventional one-product or product family campaign. Marketing or advertising, which may include various discounts, may also offer loyalty and/or incentive programs. Marketing results may benefit greatly from targeting a type of user in a marketing or advertising program, with the objective of serving that marketing or advertising campaign to the targeted user. Marketing or advertising to mobile devices such as cell phones may provide a call back number that, when it is called, the advertiser pays a fee to a provider of the cell phone network. Such an advertising payment scheme is called a pay-per-call and may be similar to pay-per-click advertising. An objective of marketing or advertising is to convince a user who may not be already known to the advertiser to become a customer or client of the advertiser or marketer. Acquisition of customers provides marketers or advertisers with valuable information on which they may target advertising, for example. Advertising networks that may include a user explicitly requesting presentation of marketing materials or advertising may make up a portion of a marketing or advertising strategy. Similarly, market research may be a critical element of a superior marketing or advertising program. Click streams of users may be used and may be analyzed to help marketers or advertisers select types of advertisements, their delivery method, delivery frequency, genre, and the like.

An interesting combination of content areas may include marketing or advertising with gaming. The content modification platform 100 may facilitate realizing this combination. In an example, a user may configure a modification feature 102 to present a link to a game instead of a link to an advertiser's website. Content modified by this feature 102 may allow a user make games available through any content that includes advertisements.

In another example, e-commerce transactions may be associated with charitable contributions. A modification feature 102 may be configured that presents a pop-up charity donation window during a checkout procedure. In this way, a user may elect to make a small contribution to a charity each time he/she makes a purchase for themselves. The charity may be automatically selected through the content modification platform 100 to be associated with the item being purchased. An e-commerce transaction to buy a book may include a charity request for helping reduce illiteracy, or a purchase of a sweater may pop-up a charity request to help homeless people. The content modification platform 100 may perform the content addition that generates the pop-up window based on the content of the checkout web page.

E-commerce may further be enhanced by the content modification platform 100 by allowing configuration of links after the user takes an action. In an example, a user may be presented with embedded dynamic advertisements that may be modifiable, although restrictions to access the content may limit what is allowed to be modified. A user may be granted greater or unlimited modification after performing an action, such as making a purchase on the e-commerce site. Before making the purchase, the user may be restricted to viewing advertisements on the site. After the purchase, the user may be allowed to present anything within the advertising area of the site—such as a photograph of his children. In this way the e-commerce site provider provides incentives to users to make a purchase.

Education or learning may benefit from aspects of the content modification platform 100. Education or learning may include a variety of actions that a user or automated system may take that may be associated with education or learning. Education or learning may be associated with a variety of other types of content, such as media, or may enrich a user's experience with education or learning. Education or learning may include a user interface 122 through which users may develop new skills, knowledge, and assess themselves. Education or learning may be elements of business platforms as herein described. Delivery of education or learning in a networked environment may include using instant messaging, e-mail, web based connection and any other form of electronic communication or information delivery. On-line education systems may include the use of video or web cameras to allow a remote user/student to view a lesson being taught. A web camera may allow a live course being presented to be delivered to a remote user through the internet. Presentation of educational information that may facilitate learning may be performed through various software programs that allow a user to interact with the learning material. Interactive tools such as question and response systems may be associated with an on-line learning environment. Education or learning may employ a variety of databases of educational material, research information, testing material, testing results, and the like. As a business platform, education or learning may be part of an employee orientation program, a technical or professional training program, and may facilitate employee retention. Education may be administered by schools such as public not for profit institutions or by profit based learning centers. To facilitate keeping on track with a learning schedule, educational material may be pushed through electronic communication or other transfer methods 110 to users. Reminders may also be pushed to users to complete material to keep pace with the expected schedule. Educators, education programs, universities, and most any sort of learning environment may include reviews of educators, material, courses, value, and the like. Reviews may include ratings against a standard or may compare aspects of education or learning relative to one another. Watchdog and consumer advocacy entities may rank educational opportunities so that consumers may have access to an unbiased assessment. Education or learning also may be associated with research and publishing tools, systems, entities, and the like.

An educator may apply a modification feature 102 to an on-line test to automatically deliver different test content for each access by a user to a test database. In an example, a user may access a test question intended to assess the user's knowledge of material reviewed earlier in an educational session. The modification feature 102 may select a content command based on the material reviewed. The selected content command may work cooperatively with the content manager 130 to replace links in the test content to redirect a test selection to the assessment questions that pertain to the reviewed material.

Communication may benefit from aspects of the content modification platform 100. Communication may include a variety of actions that a user or automated system may take that may be associated with the communication. Communication may be associated with a variety of other types of content 108, for example media, or may enrich a user's experience with communication. Communication in a networked environment may be carried out through messaging such as instant messaging or text messaging. Various forms of SMS based communication may enhance digital user to user information transfer. Email, RSS feeds, and other forms of electronic data and information exchange may be included in communication. Communication may support collaboration tools to allow remote users a flexible effective common working environment. Communication is also critical in effective program and project management.

Communication may be combined with various aspects of media to enrich a user's communication experience. The content modification platform 100 may facilitate this combination by allowing a user to customize the way communication is presented to the user. In an example, a user may prefer to cross reference email 164 as it is presented. A user may configure content commands to modify content within received email 164 to include links to other received or sent that relates to the content. Email modified in this way may include a link to an earlier email 164, rather than presenting the earlier email 164 indented below the current email 164. This allows the user to access the earlier email 164 if needed but reduces the size of each email 164 in an email 164 trail. If an email 164 has an embedded media type object such as an image, a modification feature 102 may be configured to replace the embedded object with a link to a separate file of the appropriate media type.

Searching may benefit from aspects of the content modification platform 100. Searching may include a variety of actions that a user or automated system may take that may be associated with searching. Searching may be associated with a variety of other types of content 108 that may, for example facilitate research, or may enrich a user's experience with searching. Searching may be performed using a variety of algorithms. Search results may be presented by page rank, ETL, reputation, popularity, keyword matching, metadata matching, term frequency, content type 108, and the like. Searched content may be tagged so that a user viewing the search results may be able to quickly distinguish reliable results from questionable results. Searching may be an ongoing activity with results being updated automatically. Searching within search results may apply filters to further narrow down or generate more relevant results. Clustering of search results may be useful in analyzing search operations, efficiency, and reliability. Clustering may also facilitate presenting the results by cluster rather than without clustering. Searching may include delivering results that include paid results and the paid results may be presented to the user with a visible distinction from non-paid results. Paid results may include sponsored links to sponsor sites. Metadata associated with content may be searched. Searching may be performed within categories such as movies, technical journals, patents, and the like.

A user may apply a modification feature 102 to searching so that search results that match previous searches are highlighted. The search results may be modified by content commands that remove search results that match a previous search, thereby allowing the user to view new results with each search. Search results of a patent and patent application database search may be grouped by patent family so that the family patents are not spread across the search results presentation.

The content modification platform 100 may be effectively and beneficially applied across a broad spectrum of industry platforms such as banking, securities exchange, commodities trading, health care, insurance, government, education, travel, leisure, services, hotels, restaurants, resorts, bars, cruises, child care, transportation, telecommunications, computer hardware, computer software, consumer electronics, big box retailers, small or specialty retailers, groceries, consumer package goods, real estate, construction, power, utility, municipal, raw materials, agriculture, legal, and the like.

In an example, the insurance industry may distribute modification features 102 and associated content commands to users so that as the user reviews content, key content terms may be linked to the insurer's website or an insurance industry website. This may benefit a user who may be researching for a report on the insurer. The resulting modified content may allow a user to quickly gain an appreciation for the critical nature of insurance in everyday life. Another example that combines insurance and e-commerce may allow a user to view a display advertisement for an automobile dealer with links to insurance related information for each vehicle. The links may include insurance rates, theft statistics, and the like. The links may be usefully applied to a used car display advertisement in which the cars are very diverse in model, options, age, and cost.

Any and all of the above content types 108, content environments, media types, industry platforms, and technologies may be potential sources for links or content added by the content modification platform 100. Likewise all of the above are potential environments in which the content modification platform 100 may be effectively and beneficially applied. The result is a platform that gives a user the ability to insert links or modify content in whatever environment desired.

In addition to content and content environments, the content modification platform 100 may support various technologies related to content and content handling. Technologies such as RSS for providing targeted content to users; HTTP for conventional web based interactions; web page creation and presentation languages such as HTML, XML, JAVA, and the like; SMS for communication; web searching and indexing technologies such as spiders and web crawlers; databases; file management, sharing, and storage; various and general services (e.g. SOA), and internationalization. Each of these technologies may benefit from features and capabilities of the content modification platform 100. An RSS reader may use the content modification platform 100 to present further customized content to a user by providing relevant links and highlighting elements of the content that the user directed the RSS reader to key on. Web searching and indexing technologies output may also be further customized to meet a user's preferences through the content modification platform 100.

In another example of the applicability and utility of the content modification platform 100, a modification feature 102 may be configured and activated called “Book Burro”. Content affected by this modification feature 102 may present many of the vendors of a book that one is viewing in the content. This may be facilitated by the ISBN number in a webpage being cross-referenced with other vendors using a database that finds the prices from the other vendors. This may be executed partially on a server and client, however, it may be accomplished entirely in the client side browser. The content manager 130 may perform actions that are invisible to the user such as parsing out the portion of the URL that contains the ISBN or detecting the ISBN from the content. The content command may contain or reference a database identifying the method 110 of searching to use. Since most on-line bookstores have an ability to submit queries to get their price listings, it may be possible to find the relevant pricing information for the book from each bookstore. This may be done by automatically navigating to the bookstore page on which the book is listed. Again this may be managed by the content manager 130 and information in the platform 100 database. The result is a query of the bookstore website to get the price listing and updating the content for presentation to the user. The on-line bookstores may benefit from this service so they may maintain the relevant databases on a server to accomplish the price listing lookup.

The content modification platform 100 may facilitate multi-user interaction such as gaming, virtual life, on-line training, and the like. Aspects of the content modification platform 100 such as shared databases 128, server based content commands, web service, and the like may allow a multitude of users to share a common view of content. This may benefit users associated with a group, such as when playing a multi-player on-line game. The users of the group may have the shared modification features 102 applied to content presented so that the presented content and links are the same. In an example, this may benefit a simulated group travel experience. Users may sign up for a virtual group vacation. The destination of the vacation, and therefore the content modification commands may be associated with a modification feature 102. When a user joins a group virtual tour, such as to the country Turkey, the content presented may include added content and links to sights, sounds, and other content configured in the content commands to meet a visitor's perspective of Turkey. Content to be added or linked may be found in the content and environmental examples described herein. Content associated with a visit to Istanbul may include a link to the history of Istanbul, or a link to the natural history museum, or to one or more mosques, and the like. Users may virtually visit one or more of these virtual visitor sites and then use messaging, also configured with the same modification feature 102, to exchange comments and discuss their visit.

Content information may flow through the content modification platform 100 as follows. The source content 108 may be retrieved by the native program or application (web page is retrieved by a web browser, text document by a text editor, video by a multimedia viewer). The source content 108 may be presented to the content modification platform 100 elements such as the content manager 130. The content manager 130 may compare aspects of the content as herein described to criteria configured in modification features 102, content commands 128, and the like to determine if the source content 108 should be modified. If the content manager 130 determines a modification feature 102 is active and its criteria sufficiently matches the aspects of the source content 108, the modification feature 102 is applied to the source content 108 to present modified content to the user. The result is that every web page visited, every document opened, every video viewed, and all content presented to the user may optionally include links or modified content before it is presented to the user. This allows every webpage for every web site visited to contain live functionality as defined by the user in one or more modification features 102. In an example, the content modification platform 100 may be used to insert a configuration screen to every web page and dialog box such as in an operating system that may be presented to a user. The content modification platform 100 includes features and elements that allow a user to develop menus 118 or buttons in a browser frame, to generate frames inside presented web pages, to present floating menu bars, present pop-ups that could be accessed by left or right clicking on parts of presented content, voice interfaces, configure hot keys, and the like.

When content is sourced into a browser or other content presentation/user interaction system as herein described, a script (e.g. a Java or XML script) may be loaded and run in the same context as the content. The script may embody elements of the content modification platform 100 such as the content manager 130. In this way, the browser needs no modification to support the platform 100.

As herein described, the content modification platform 100 may be a browser based platform that may work cooperatively with or as an alternate to existing web browser technology. The features 102, menus, buttons, and other user interface aspects of the platform may be configurable within or dynamically integrated with existing and future web browsing technology. Alternatively, the platform 100 may include these elements as a stand alone content presentation and user interaction system or program. The platform 100 may also include an environment suitable for development of the platform 100. The development environment may provide debugging, testing, version checking, compiling, commenting, archiving, and other capabilities that may efficiently and effectively facilitate development of existing or new platform 100 elements or new platforms 100.

The platform 100 may allow users to develop their own menu feature 102 menus 112, buttons, and the like through the use of feature templates. Feature or button templates may include selected aspects that are user configurable, that a user can change. In an example, a template may allow a user to identify a link to be presented for a work or phrase in the content. A search template may allow a user to configure a modification feature 102 that returns search results based on content selected. Search templates may allow a user to specify a plurality of search tools/sources (Google, Ask Jeeves, Yahoo Search) to employ. The results may be passed to another modification feature 102 that may order the results according to a user preference and tag each result with its search tool/source. The result may be a common search map of search results associated with the selected portion of the source content 108.

Templates may provide a form of building block for development that may allow the templates to be linked into applications. Web site developers may easily adapt templates or linked templates (that may be available in an advanced development area of the platform 100) to offer services provided by the content modification platform 100 as part of a web site. This may increase the utility and functionality of the content modification platform 100 by extending its applications. Link templates may facilitate a web developer to hardcode words or phrases to links on their site. Search templates may facilitate hard coding of a search engine selection or search engine input window. In an example of linking templates, an instant messenger address (e.g. URL) lookup may be a functional block built on a template that that may be used to provide inputs to other templates to build up an application. Another example of a template is a driving direction template. The template may allow a user to configure it with “my home address” so that when the template is applied to content, it can automatically return driving directions to/from “my home address” to/from a destination derived from source content. It will be appreciated that templates may be configured for any combination, interaction, or action associated with content. Therefore the examples and descriptions herein are only representative samples of the possible templates and uses of templates in association with the content modification platform 100.

Other uses of the content modification platform 100 may include on-line brokerages to configure modification features 102 to allow one-click stock trading. In an example, e-trade may provide a modification feature 102 that inserts an icon (e.g. an e-trade logo) next to each stock symbol that, when clicked performs a one click trade of the stock into/out of the user's e-trade brokerage account. Modification features 102 could be configured to add PayPal or debit card icons near prices of items in e-commerce, auction, or classified listing content to facilitate one-click purchasing of the item by PayPal or a users' debit card.

Various other uses/applications of the content modification platform 100 include conversion or lookup of codes (UPC, EIN, ISBN, and etceteras), lookup and presentation or linking to profiles of companies in business research sites such as Hoovers, blending games with auctions so that a user can participate in an on-line auction as if the player were at an auction site, including a slice of a user interface of a game into a word processing document, create and share favorite music lists including identifying a song that may be represented in source content that is also on a shared favorite music list so that I can easily see what my friends have listed as their favorites while browsing music related sites, news selection (e.g. digg.com) and presentation or creation.

The services described herein may be accessed by a web service subscription. Revenue models associated with a web service may be a no-cost subscription; a fee subscription for all services; a fee subscription for only premium services; a licensed service with advertisements; licensing the service or components thereof to users, user groups, or communities wishing to build their own feature buttons or indices; affiliate fees; payment for inclusion of feature buttons or indices such as on a flat, per-click, or per-view basis; and the like. In an example, a no-fee subscription may grant a user access to features such as inserting hyperlinks 192 but not to other features such as index-enabled searching. Affiliates may be e-commerce sites, search sites, and the like. Affiliates may pay to have their links, content, features, buttons, and/or indices available through the service. Affiliates or other clients may pay to have a logo or other content included on a feature button, index or elsewhere in the user interface 122. In an example, Amazon.com may pay to distribute their index to users to enable web searching. Optionally, users may be granted a no-fee subscription if they accept index-enabled web searching from affiliates. Revenue may be shared with companies or individuals. The types of companies or individuals who may share revenue include feature button creators, index creators, creators of other functionality/content, vendors who sell subscriptions to a feature button or an index that filters links, and the like.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method, comprising:
providing a content modification platform;
associating the content modification platform with a content environment;
defining a plurality of available content modifications associated with the modification platform, the plurality of available content modifications being based on at least one of the nature of the content environment and a plurality of content modification sources;
presenting the plurality of available content modifications to a user in the content environment; and
upon input by the user, modifying the content in the content environment using content from at least one content modification source.

2. The method of claim 1, wherein content is at least one of a web site, a web page, a document, a message, an explorer view, a database, an email 164, an RSS feed, a task, a business platform, a media item, an advertisement, a transactional item, a game, and an industry platform.

3. The method of claim 1, wherein modifying is based on a relevance of an aspect of the content.

4. The method of claim 3, wherein the aspect is metadata associated with the content.

5. The method of claim 3, wherein the aspect is a domain of the content.

6. The method of claim 3, wherein the aspect is a URL of the content.

7. The method of claim 3, wherein the aspect is keywords of the content.

8. The method of claim 1, wherein modifying includes finding keywords in content.

9. The method of claim 1, wherein modifying includes adding content.

10. The method of claim 1, wherein the content modification platform is embodied as at least one of a local program, a client program, a server program, a web browser plug-in, a web service, and a DOM API.

11. The method of claim 1, wherein presenting includes presenting a menu feature associated with a content source.

12-15. (canceled)

16. A method comprising:
providing a content modification platform;
selecting content;
selecting alternate content;
defining a menu feature that associates the content to the alternate content; and
connecting the menu feature to the platform so that the menu feature is available to a user of the platform.

17. The method of claim 16, further comprising selecting the menu feature to take an action that results in a presentation of modified content based on the defined content association.

18. The method of claim 17, wherein the action includes at least one of adding, removing, translating, paraphrasing, expanding, highlighting, disguising, converting, redirecting, and previewing.

19. The method of claim 16, wherein the menu feature is user defined.

20. The method of claim 16, wherein the menu feature is self-authored.

21. The method of claim 16, wherein the menu feature is purchased.

22. The method of claim 16, wherein the menu feature is authored by a third party.

23. The method of claim 16, wherein the menu feature is automatically generated.

24-30. (canceled)

31. A system, comprising:
a content modification platform;
a content environment that is associated with the content modification platform;
a plurality of available content modifications associated with the modification platform, the plurality of available content modifications being based on at least one of the nature of the content environment and a plurality of content modification sources; and
a presentation of available content modifications that is provided by the content modification platform to a user in the content environment; wherein
the content modification platform is adapted to modify the content in the content environment, upon input from the user, using content from at least one content modification source.

32-60. (canceled)
